(19) United States
(12) Patent Application Publication
(10) Pub. No.: US 2017/0350632 A1
(43) Pub. Date: Dec. 7, 2017

(54) LIQUEFIED GAS COOLING APPARATUS

(71) Applicant: MITSUBISHI HEAVY INDUSTRIES THERMAL SYSTEMS, LTD., Tokyo (JP)

(72) Inventors: Toyotaka HIRAO, Tokyo (JP); Kenji UEDA, Tokyo (JP); Yasushi WATANABE, Tokyo (JP)

(73) Assignee: MITSUBISHI HEAVY INDUSTRIES THERMAL SYSTEMS, LTD., Tokyo (JP)

(21) Appl. No.: 15/538,064

(22) PCT Filed: Dec. 24, 2015
(86) PCT No.: PCT/JP2015/086146

§ 371 Date: Jun. 20, 2017

(30) Foreign Application Priority Data
Jan. 5, 2015 (JP) 2015-000504

(51) Int. Cl. F25B 45/00; F25B 31/02; F25J 1/00

(52) U.S. Cl. CPC F25B 45/00; F25J 1/0022; F25B 31/02; F17C 2227/0337; F17C 2221/033

(57) ABSTRACT

A liquefied gas cooling apparatus includes: a gas flow path for carrying a liquefied gas that is liquefied by cooling; and a refrigeration unit including a refrigerating cycle formed by an evaporator for cooling the liquefied gas flowing through the gas flow path, a compressor, a condenser, and a throttle expansion unit. The refrigeration unit includes: an inlet-side open/close valve and an outlet-side open/close valve provided in an inlet path and an outlet path of the compressor, respectively; and a service open/close valve in a refrigerant path between the inlet-side open/close valve and the outlet-side open/close valve.

### TECHNICAL FIELD

The present invention relates to a cooling apparatus (hereinafter simply referred to as a liquefied gas cooling apparatus) for cooling liquefied gas for liquefaction.

### BACKGROUND ART

For example, a liquefied natural gas (hereinafter also simply referred to as LNG) is generated by first precooling a natural gas at room temperature under normal pressure to about −30° C., further cooling the resulting gas to liquefy the gas, and further supercooling the liquefied gas to −162° C. This cooling process employs refrigeration units using various refrigerants. Each refrigeration unit has a compressor, a condenser, a throttle expansion unit, and an evaporator connected in sequence in a refrigerant path, thereby forming a closed refrigerating cycle.

PTLs 1 to 5 each disclose a liquefied gas cooling apparatus for an LNG and the like, using a refrigeration unit as described above. These liquefied gas cooling apparatuses each include different refrigeration units having needed performances for a precooling process and a liquefaction process.

### CITATION LIST

### Patent Literature

### {PTL 1}

U.S. Patent Application, Publication No. 2009/0090131

### {PTL 2}

U.S. Patent Application, Publication No. 2010/0281915 (corresponding to Japanese Unexamined Patent Application, Publication No. 2010-261038)

### {PTL 3}

U.S. Patent Application, Publication No. 2010/0257895

### {PTL 4}

U.S. Patent Application, Publication No. 2014/0190205

### {PTL 5}

U.S. Patent Application, Publication No. 2014/0283550

### SUMMARY OF INVENTION

### Technical Problem

In a refrigeration unit in such a liquefied gas cooling apparatus, a drive shaft of a compressor in a refrigerating cycle is coupled to an output shaft of a gas turbine or electric motor to drive the compressor. This compressor requires, at regular operation intervals, change of consumable parts, such as bearings, involving the collection of the refrigerant from the refrigerating cycle for maintenance. Hence, the liquefied gas cooling apparatus cannot be operated during that time, which leads to a problem of, for example, interruption of LNG production.

Meanwhile, the compressor is driven via a turbine shaft or motor shaft, which causes an infinitesimal amount of refrigerant leaking from the shaft sealing portion of the compressor drive shaft; thus, the refrigerant needs to be regularly added. Compressors and turbines are arranged in lines by group; thus, rigid constraints are imposed on arrangement of component machines in plants with small installation spaces. In addition, in some cases during maintenance, some of the refrigeration units in multiple grids are halted to avoid the halt of the entire system and the other refrigeration units are operated for maintenance. At this time, the drive motors in the halted compressors or the power sections of the inverters may be in an electrically conducting state, which may become dangerous for maintenance work.

It is an object of the present invention, which has been made in consideration of such circumstances, to provide a liquefied gas cooling apparatus that facilitates compressor maintenance, shortens its maintenance time, and allows a system to be operated while the compressors are partly subjected to maintenance.

### Solution to Problem

To solve the aforementioned problem, a liquefied gas cooling apparatus of the present invention employs the following solutions.

To be specific, a liquefied gas cooling apparatus according to the present invention includes: a gas flow path for carrying a liquefied gas that is liquefied by cooling; and a refrigeration unit including a refrigerating cycle formed by an evaporator for cooling the liquefied gas flowing through the gas flow path, a compressor, a condenser, and a throttle expansion unit. The refrigeration unit includes: an inlet-side open/close valve and an outlet-side open/close valve provided in an inlet path and an outlet path of the compressor, respectively; and a service open/close valve in a refrigerant path between the inlet-side open/close valve and the outlet-side open/close valve.

According to the present invention, when compressor maintenance is needed after a lapse of a predetermined operation time, the operation of the compressor is halted and the open/close valves provided in the inlet path and the outlet path of the compressor are closed.

Consequently, while the compressor is separated from the refrigerating cycle, the refrigerant in the compressor can be collected through a service port and the compressor can be then subjected to maintenance.

Hence, during the maintenance of the compressor, not all the refrigerant in the refrigerating cycle needs to be collected, so that the work time can be shortened, maintenance work including work for collecting the refrigerant can be facilitated, and maintenance costs, such as personnel costs and refill refrigerant costs, can be reduced.

Compressor maintenance is performed at an appropriate timing by, for example, counting the operation time and giving a notice.

Further, as for a liquefied gas cooling apparatus of the present invention, in the aforementioned liquefied gas cooling apparatus, the service port including the service open/close valve, and the inlet-side open/close valve, the outlet-side open/close valve, and the compressor are modularized into multiple compressor modules connected in parallel to the refrigerating cycle.

According to the present invention, after lapse of the respective prescribed operation times, the operations of the multiple compressors connected in parallel are halted in sequence, and they are independently subjected to maintenance as described above, so that the multiple compressors can be subjected to maintenance in sequence by rotation.

Accordingly, the necessity of entirely halting the liquefied gas cooling apparatus is removed and the compressors can be independently subjected to maintenance while the operation of the apparatus is continued.

Further, as for a liquefied gas cooling apparatus of the present invention, in the aforementioned liquefied gas cooling apparatus, the refrigeration unit is modularized for each refrigerating cycle into multiple refrigeration modules connected in parallel or series to the gas flow path for the liquefied gas.

After lapse of the respective prescribed operation times of compressors in the modularized refrigeration units, the operations of the refrigeration modules containing these compressors are halted in sequence, and the compressors are independently subjected to maintenance as described above, so that the compressors in the multiple refrigeration modules can be subjected to maintenance in sequence by rotation.

Accordingly, the necessity of entirely halting the liquefied gas cooling apparatus is removed and the compressors can be independently subjected to maintenance while the operation of the apparatus is continued.

Further, as for a liquefied gas cooling apparatus of the present invention, in the aforementioned liquefied gas cooling apparatus, the multiple refrigeration modules are connected in parallel to the gas flow path, and a flow path open/close valve is provided in the gas flow path on one or both of an inlet side and an outlet side with respect to the evaporator of each refrigeration module.

According to the present invention, when the compressors in the modularized refrigeration units are subjected to maintenance in sequence by rotation after lapse of the respective prescribed operation times, the liquefied gas flow path to the evaporator of the refrigeration module in the halt state is blocked by closing the open/close valve on one or both of the inlet and outlet sides thereof, thereby allowing for maintenance.

Accordingly, a decrease in cooling efficiency due to the mixing of an uncooled liquefied gas into the liquefied gas cooled in the other refrigeration modules can be alleviated. Thus, the cooling performance can be improved.

### Advantageous Effects of Invention

According to the present invention, when compressor maintenance is needed after a lapse of a predetermined operation time, the operation of the compressor is halted and the open/close valves in the inlet path and the outlet path of the compressor are closed.

Consequently, while the compressor is separated from the refrigerating cycle, the refrigerant in the compressor can be collected through the service port and the compressor can be then subjected to maintenance.

Therefore, during the maintenance of the compressor, not all the refrigerant in the refrigerating cycle needs to be collected, so that the work time can be shortened, maintenance work including work for collecting the refrigerant can be facilitated, and maintenance costs, such as personnel costs and refill refrigerant costs, can be reduced.

### BRIEF DESCRIPTION OF DRAWINGS

FIG. 1 is a partial configuration diagram of a liquefied gas cooling apparatus according to the first embodiment of the present invention.

FIG. 2 is a schematic configuration diagram of a compressor in a refrigeration unit used for the liquefied gas cooling apparatus.

FIG. 3 is a partial configuration diagram of a liquefied gas cooling apparatus according to the second embodiment of the present invention.

FIG. 4 is a partial configuration diagram of a liquefied gas cooling apparatus according to the third embodiment of the present invention.

### DESCRIPTION OF EMBODIMENTS

Embodiments of the present invention will now be explained with reference to the drawings.

### First Embodiment

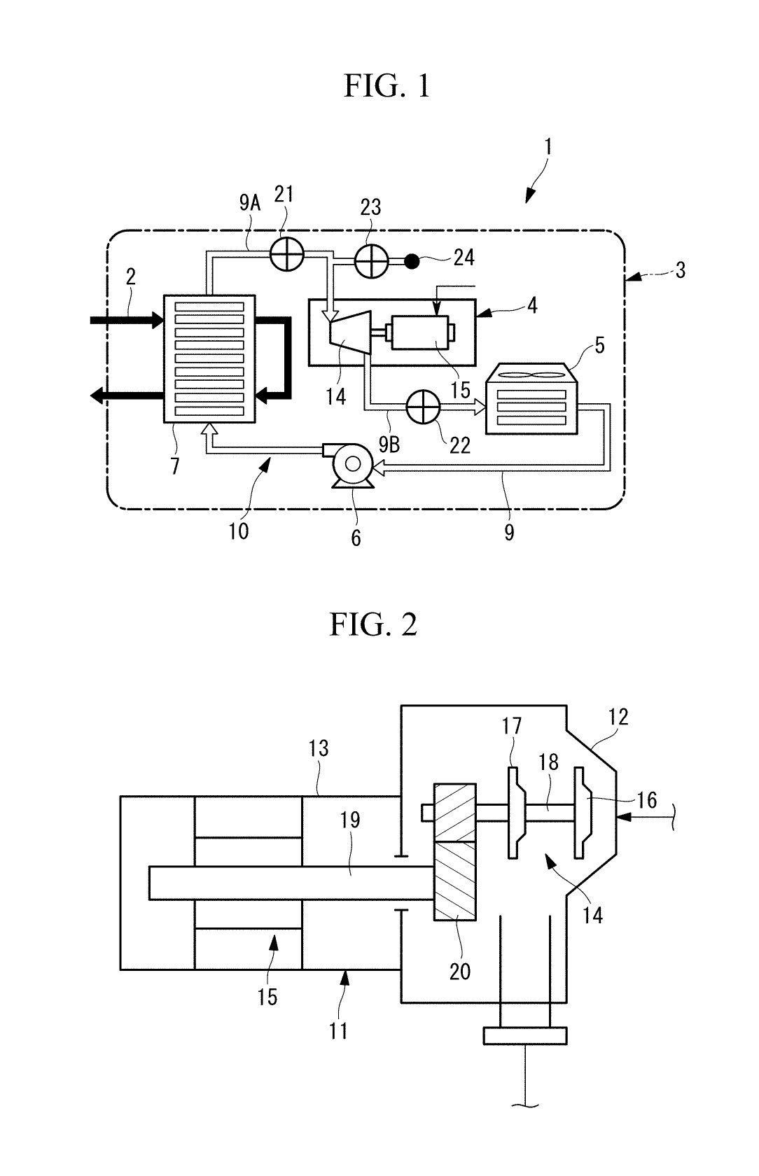

A first embodiment of the present invention will now be explained with reference to FIGS. 1 and 2.

FIG. 1 is a partial configuration diagram of a liquefied gas cooling apparatus according to the first embodiment of the present invention, and FIG. 2 is a schematic configuration diagram of a compressor in a refrigeration unit used for that apparatus.

The liquefied gas cooling apparatus 1 includes a gas flow path 2 carrying a liquefied gas (feedstock) such as a natural gas, and refrigeration unit 3 for cooling the liquefied gas in the gas flow path 2 to a predetermined temperature.

Each refrigeration unit 3 includes, like a known one, a compressor 4 for compressing the refrigerant, a condenser 5 for condensation-liquefaction of the high-temperature and high-pressure refrigerant gas compressed by the compressor 4, a throttle expansion unit 6 for adiabatic expansion of the refrigerant condensed by the condenser 5, and an evaporator 7 for evaporation of the low-temperature and low-pressure refrigerant resulting from the adiabatic expansion by the throttle expansion unit 6, connected in this order through a refrigerant path 9, thereby forming a closed refrigerating cycle 10. Any expander or expansion valve may be used as the throttle expansion unit 6.

The gas flow path 2 carrying the liquefied gas to liquefy is sequentially cooled through the evaporator 7 of the refrigeration unit 3, and the natural gas serving as a feedstock is transferred to the downstream process to become a liquefied gas (LNG) at −162° C.

As shown in FIG. 2, the compressor 4 used in the refrigeration unit 3 is a sealed electric compressor containing a compressor mechanism 14 and an electric motor 15 in a sealed housing 11 consisting of a compressor housing 12 and a motor housing 13 coupled to each other through a bolt or the like. The compressor 4 here is a turbo compressor including upper and lower two impellers 16 and 17 having a rotation shaft 18 driven though a speed-up gear 20 with the use of a motor shaft 19 rotatably supported through a bearing not shown in the drawing.

The compressor 4, which is a two-stage compressor including upper and lower two impellers 16 and 17 here, may be a single-stage compressor or multiple-stage compressor with three or more stages. Although its rotation shaft 18 is driven through the speed-up gear 20 with the use of the motor shaft 19, it may be a direct-coupled compressor in which the rotation shaft 18 and the motor shaft 19 are integrally formed into one shaft.

The inlet path 9A and the outlet path 9B of the compressor 4 are provided with an inlet-side open/close valve 21 and an outlet-side open/close valve 22, respectively, so that the refrigerating cycle 10 can be blocked, and a service port 24 including a service open/close valve 23 is provided in the refrigerant path 9 between the inlet-side open/close valve 21 and the outlet-side open/close valve 22.

With the aforementioned configuration, this embodiment provides the following advantageous effects.

To generate a liquefied gas (LNG) by, for example, cooling a raw-material gas, such as a natural gas, using the liquefied gas cooling apparatus 1, the refrigeration units 3 are operated, and the liquefied gas at room temperature flowing through the gas flow paths 2 is therefore sequentially cooled by the evaporators 7, i.e., first pre-cooled to about −30° C., further cooled, and then super-cooled to yield a liquefied gas (LNG) at −162° C.

The compressor 4 provided in the refrigeration unit 3 and operated in the liquefaction cooling process requires maintenance at predetermined operation intervals for change of consumable parts, such as bearings. Each time, it is necessary that the compressor 4 be brought into the halt state, the refrigerant be collected from the interior, and maintenance be then carried out. A process for this maintenance will be explained in detail below.

(1) The operation time of the compressor 4 is counted by a controller or the like. After a lapse of a predetermined operation time, a notice is given through an appropriate means, so that a necessity of maintenance is determined; thus, the operation of the refrigeration unit 3 is halted.
(2) After the compressor 4 is brought into the halt state, the open/close valves 21 and 22 provided in the inlet path 9A and the outlet path 9B are closed to block the refrigerating cycle 10; thus, the compressor 4 is separated from the refrigerating cycle 10.
(3) In this state, a refrigerant collecting machine is connected to the service port 24 and the service open/close valve 23 is opened, so that the refrigerant in the compressor 4 is collected into a tank or the like on the refrigerant collecting machine side.
(4) Afterwards, needed maintenance, e.g., the change of consumable parts, such as bearings, in the compressor 4 is carried out.
(5) After the maintenance is terminated, the compressor 4 is evacuated through a vacuum pump connected to the service port 24, and refilled with a necessary amount of refrigerant through a refrigerant filling machine connected to the service port 24.
(6) After the refilling of the refrigerant is terminated, the service open/close valve 23 is closed and the open/close valves 21 and 22 provided in the inlet path 9A and the outlet path 9B are opened, so that the maintenance work is completed and the compressor 4 and the refrigeration unit 3 are ready for operation.

According to this embodiment, the compressor 4 can be subjected to maintenance in the aforementioned process. Hence, during the maintenance of the compressor 4, not all the refrigerant in the refrigerating cycle 10 needs to be collected, so that the work time can be shortened, maintenance work including work for collecting the refrigerant can be facilitated, and maintenance costs, such as personnel costs and refill refrigerant costs, can be reduced.

Further, the compressor 4 of this embodiment is a sealed electric compressor containing the compressor mechanism 14 and the electric motor 15 in the sealed housing 11. Hence, the shaft sealing portions of the compressor drive shaft are removed, thereby preventing a refrigerant leakage from the shaft sealing portions.

This can omit regular additional refill of refrigerant and reduce the related maintenance costs, refrigerant costs, and the like, thus enhancing the usage rate of the system.

In addition, the machine installation space can be saved compared with a gas turbine drive system, so that the constraints of machine layouts in small plants can be eased.

### Second Embodiment

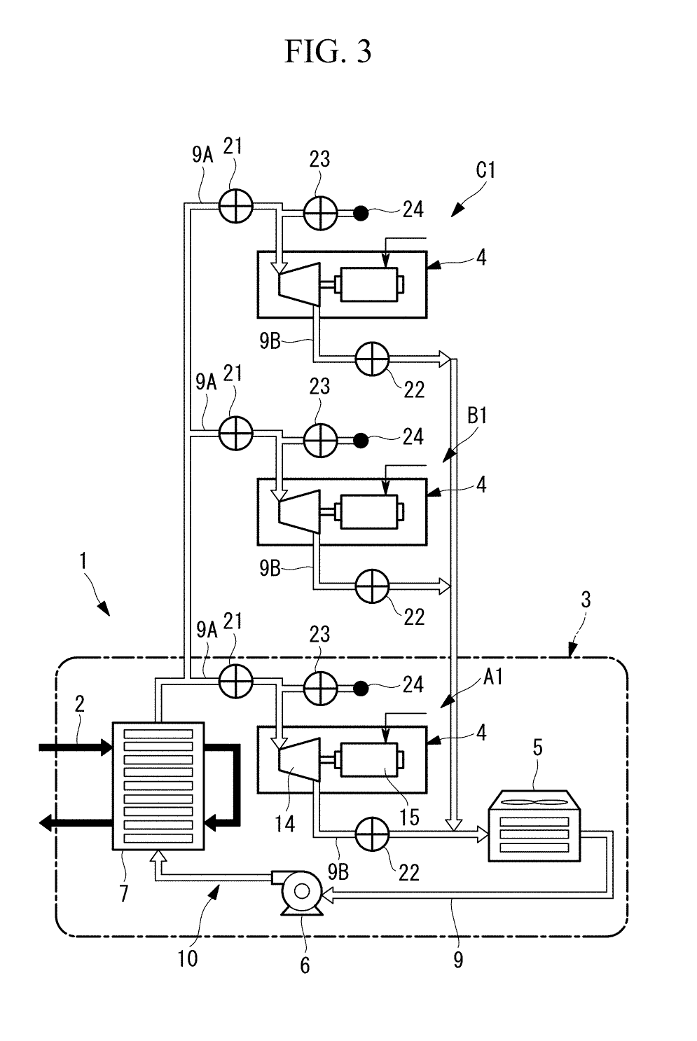

A second embodiment of the present invention will now be explained with reference to FIG. 3.

This embodiment differs from the first embodiment in that it includes multiple modularized compressors 4 connected in parallel to a refrigerating cycle 10. The other configuration is the same as in the first embodiment and will therefore not be explained.

As shown in FIG. 3, in the liquefied gas cooling apparatus 1 of this embodiment, each compressor 4 is modularized integrally with the open/close valves 21 and 22 provided in the inlet path 9A and the outlet path 9B, the service port 24 including the service open/close valve 23 provided in the refrigerant path 9 between the inlet-side open/close valve 21 and the outlet-side open/close valve 22, and the like, and the resulting compressor modules A1, B1, and C1 . . . are connected in parallel to the refrigerating cycle 10.

Since the modularized multiple compressors 4 are connected in parallel to the refrigerating cycle 10 in this manner, after lapse of the respective predetermined operation times, the operations of the compressors 4 of the multiple compressor modules A1, B1, and C1 can be sequentially halted and independently subjected to maintenance according to the aforementioned steps (2) to (6), allowing compressor maintenance to be performed by rotation.

Accordingly, each time the compressors 4 are subjected to maintenance, the necessity of halting the operation of the liquefied gas cooling apparatus 1 is removed and the compressors 4 can be independently subjected to maintenance while the operation of the apparatus is continued, so that the usage rate of the liquefied gas cooling apparatus 1 can be improved.

Similarly, even in the event of any of the multiple compressor modules A1, B1, and C1 suffering a breakdown and becoming inoperative, a repair can be made on that compressor module while the operation of the liquefied gas cooling apparatus 1 is continued, thereby avoiding a drop in the production of the liquefied gas (LNG).

Further, a configuration in which the modularized multiple compressors 4 are connected in parallel to the refrigerating cycle 10 leads to not only a reduction in the capacity of each compressor 4 but also reductions in the diameters of the open/close valves 21, 22, and 23 and the like, thereby achieving a range of specifications that can be easily put to practical use.

### Third Embodiment

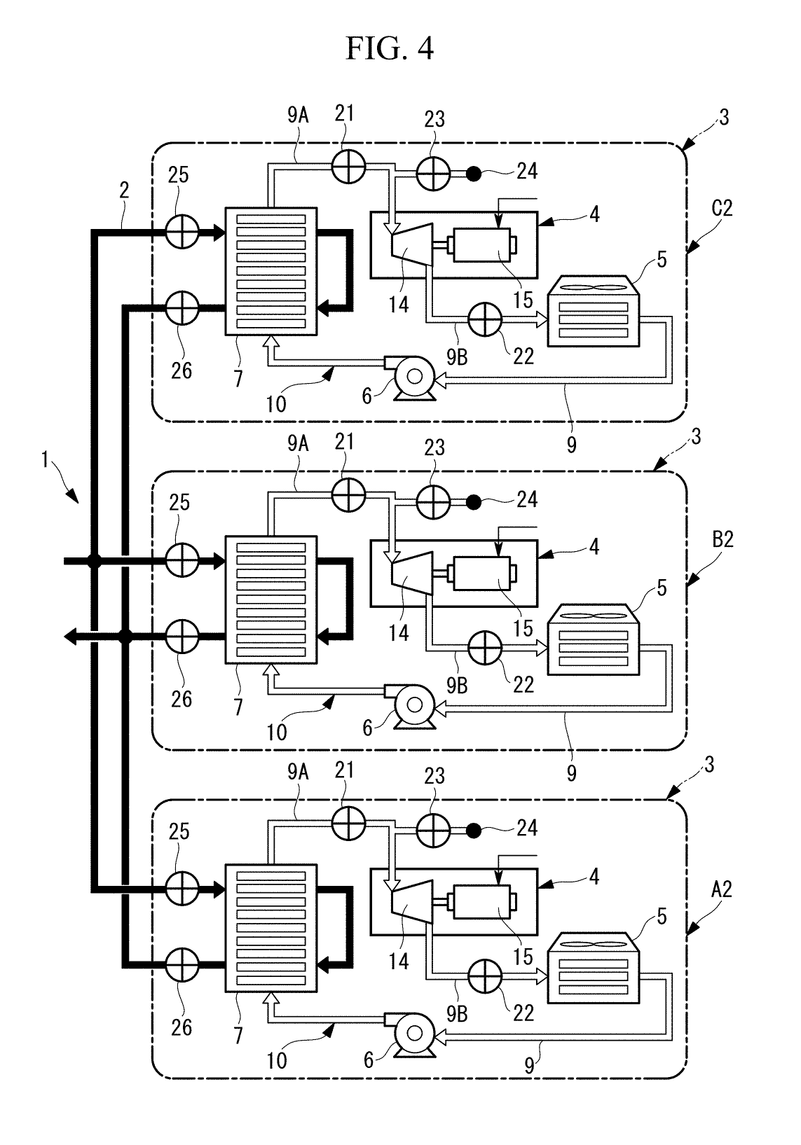

A third embodiment of the present invention will now be explained with reference to FIG. 4.

This embodiment differs from the first embodiment in that it includes multiple modularized refrigeration units 3 connected in parallel to the gas flow path 2 for the liquefied gas. The other configuration is the same as in the first embodiment and will therefore not be explained.

As shown in FIG. 4, the liquefied gas cooling apparatus 1 according to this embodiment includes compressors 4, condensers 5, throttle expansion units 6, and evaporators 7 connected in sequence through the refrigerant paths 9, forming closed refrigerating cycles 10.

Inlet-side and outlet-side open/close valves 21 and 22 are provided in the inlet path 9A and the outlet path 9B of the compressor 4 in each refrigerating cycle 10, and a refrigeration unit 3 in which a service port 24 including a service open/close valve 23 is provided in the refrigerant path 9 between the inlet-side and outlet-side open/close valves 21 and 22 is modularized for each refrigerating cycle 10.

Further, the multiple refrigeration modules A2, B2, C2 . . . are connected in parallel to the gas flow path 2 for the liquefied gas.

Flow path open/close valves 25 and 26 are provided in the gas flow path 2 on one or both of the inlet and outlet sides with respect to the evaporator 7 of each of the multiple refrigeration modules A2, B2, and C2 connected in parallel to the gas flow path 2 for the liquefied gas.

Thus, in the event of any of the multiple refrigeration modules A2, B2, and C2 undergoing maintenance for the compressor 4, suffering a breakdown, or being in the halt state for other reasons, a flow of the liquefied gas to any of the refrigeration modules A2, B2, and C2 can be blocked.

As described above, the multiple refrigeration modules A2, B2, and C2 modularized for the respective refrigerating cycles 10 are connected in parallel to the gas flow path 2 for the liquefied gas. After lapse of the respective prescribed operation times of the compressors 4 of these modularized refrigeration units 3, the operations of the refrigeration modules A2, B2, and C2 including these compressors 4 are halted in sequence. In addition, the compressors 4 can be independently subjected to maintenance according to the aforementioned steps (2) to (6), allowing compressor maintenance to be performed by rotation.

Accordingly, each time the compressors 4 are subjected to maintenance, the necessity of halting the operation of the liquefied gas cooling apparatus 1 is removed and the compressors 4 of the refrigeration modules A2, B2, and C2 can be independently subjected to maintenance while the operation of the apparatus is continued, so that the usage rate of the liquefied gas cooling apparatus 1 can be improved.

Similarly, even in the event a component machine or the like of any of the multiple refrigeration modules A2, B2, and C2 suffers a breakdown and becomes inoperative, a repair can be made on the any of the refrigeration modules A2, B2, and C2 while the operation of the liquefied gas cooling apparatus 1 is continued, thereby avoiding a drop in the production of the liquefied gas.

Flow path open/close valves 25 and 26 are provided in one or both of the gas flow path 2 on the inlet and outlet sides with respect to the evaporator 7 of each of the multiple refrigeration modules A2, B2, and C2. Hence, after lapse of the respective predetermined operation times, the compressors 4 of the modularized refrigeration units 3 can be subjected to maintenance in sequence by rotation.

In this case, the liquefied gas flow paths to the evaporators 7 of the refrigeration modules A2, B2, and C2 in the halt states are blocked by closing the open/close valves 25 and 26 on one or both of the inlet and outlet sides of each evaporator 7, thereby allowing for maintenance.

Accordingly, a decrease in cooling efficiency due to the mixing of an uncooled liquefied gas, which flows through the refrigeration modules in the halt states, into the liquefied gas cooled in the other refrigeration modules A2, B2, and C2 connected in parallel can be alleviated. Thus, the cooling performance can be improved.

Further, the refrigeration unit 3 is divided into the multiple refrigeration modules A2, B2, C2 . . . having low capacities, and the multiple refrigeration modules A2, B2, and C2 are connected in parallel to the gas flow path 2 for the liquefied gas.

This provides high flexibility in machine layout compared with the case where a single large refrigeration unit 3 having the same performance is installed and eases the constraints of machine layouts in plants with small installation spaces, so that the performance level of the liquefied gas cooling apparatus 1 can be flexibly selected.

In addition, the diameters of the open/close valves 21, 22, 23, 25, 26, and the like provided in the refrigerating cycle 10 and the gas flow path 2 can also be reduced, thereby achieving a range of specifications that can be easily put to practical use.

The present invention should not be limited to the invention according to the above-described embodiments and appropriate modifications can be made without departing from the scope of the present invention.

For example, although the above-described embodiments use turbo compressors as the compressors 4 used in the refrigeration units 3, this is not necessarily the case: other types of compressors, such as screw compressors and reciprocating compressors, may be used instead.

Needless to say, the liquefied gas cooling apparatus according to the present invention can also be used for liquefaction of a liquefied gas other than natural gas.

Although the third embodiment shows an example where the multiple refrigeration modules A2, B2, C2 . . . are connected in parallel to the gas flow path 2 carrying the liquefied gas, the multiple refrigeration modules A2, B2, and C2 are not necessarily connected in parallel and may be connected in series to the gas flow path 2. In this case where the gas flow path 2 is connected in series to the evaporators 7 of the refrigeration modules A2, B2, and C2, the flow path open/close valves 25 and 26 may be omitted or a bypass circuit be provided.

### REFERENCE SIGNS LIST

1 liquefied gas cooling apparatus
2 gas flow path
3 refrigeration unit
4 compressor
5 condenser
6 throttle expansion unit
7 evaporator
9 refrigerant path
9A inlet path
9B outlet path
10 refrigerating cycle
21, 22 open/close valve
23 service open/close valve
24 service port
25, 26 flow path open/close valve
A1, B1, C1 compressor module
A2, B2, C2 refrigeration module

1-10. (canceled)

11. A maintenance method for a liquefied gas cooling apparatus comprising:
a gas flow path for carrying a liquefied gas that is liquefied by cooling; and
a refrigeration unit including a refrigerating cycle formed by an evaporator for cooling the liquefied gas flowing through the gas flow path, a sealed compressor containing a compressor mechanism and an electric motor, a condenser, and a throttle expansion unit, the refrigeration unit comprising:
an inlet-side open/close valve and an outlet-side open/close valve provided in an inlet path and an outlet path of the compressor, respectively; and
a service port including a service open/close valve provided in a refrigerant path between the inlet-side open/close valve and the outlet-side open/close valve, the method comprising the steps of:
closing the inlet-side open/close valve and the outlet-side open/close valve after the compressor is brought into a halt state;
connecting a refrigerant collecting machine to the service port to open the service open/close valve;
collecting refrigerant in the compressor to the refrigerant collecting machine; and
performing maintenance on the compressor.

12. The maintenance method for a liquefied gas cooling apparatus according to claim 11, comprising the steps of:
evacuating the compressor by using a vacuum pump connected to the service port;
refilling a necessary amount of refrigerant by using a refrigerant filling machine connected to the service port; and
closing the service open/close valve and opening the inlet-side open/close valve and the outlet-side open/close valve.

13. The maintenance method for a liquefied gas cooling apparatus according to claim 11, further comprising the step of:
prior to the step of closing the inlet-side open/close valve and the outlet-side open/close valve, counting the operation time of the compressor and, after a lapse of a predetermined operation time, giving a notice of the lapse of the operation time.

14. The maintenance method for a liquefied gas cooling apparatus according to claim 11, wherein
the service port including the service open/close valve, and the inlet-side open/close valve, the outlet-side open/close valve, and the compressor are modularized into multiple compressor modules connected in parallel to the refrigerating cycle, the method further comprising the step of:
prior to the step of closing the inlet-side open/close valve and the outlet-side open/close valve, stopping the operations of, out of the compressors of the multiple compressor modules, the compressors operating over predetermined operation times.

15. The maintenance method for a liquefied gas cooling apparatus according to claim 11, wherein
the refrigeration unit is modularized for each refrigerating cycle into multiple refrigeration modules connected in parallel or series to the gas flow path for the liquefied gas, the method further comprising the step of:
prior to the step of closing the inlet-side open/close valve and the outlet-side open/close valve, stopping the operations of, out of the multiple refrigeration modules, the refrigeration units including the compressors operating over predetermined operation times.

16. The maintenance method for a liquefied gas cooling apparatus according to claim 15, wherein
the multiple refrigeration modules are connected in parallel to the gas flow path and a flow path open/close valve is provided in the gas flow path on one or both of inlet side and outlet side with respect to the evaporator of each refrigeration module, the method further comprising the step of:
closing the flow path open/close valve of the refrigeration module in the halt state.

17. A liquefied gas cooling apparatus comprising:
a gas flow path for carrying a liquefied gas that is liquefied by cooling; and
a refrigeration unit including a refrigerating cycle formed by an evaporator for cooling the liquefied gas flowing through the gas flow path, a sealed compressor containing a compressor mechanism and an electric motor, a condenser, and a throttle expansion unit, the refrigeration unit comprising:
an inlet-side open/close valve and an outlet-side open/close valve provided in an inlet path and an outlet path of the compressor, respectively; and
a service open/close valve in a refrigerant path between the inlet-side open/close valve and the outlet-side open/close valve.

18. The liquefied gas cooling apparatus according to claim 17, wherein a service port including the service open/close valve, and the inlet-side open/close valve, the outlet-side open/close valve, and the compressor are modularized into multiple compressor modules connected in parallel to the refrigerating cycle.

19. The liquefied gas cooling apparatus according to claim 17, wherein the refrigeration unit is modularized for each refrigerating cycle into multiple refrigeration modules connected in parallel or series to the gas flow path for the liquefied gas.

20. The liquefied gas cooling apparatus according to claim 19, wherein the multiple refrigeration modules are connected in parallel to the gas flow path, and a flow path open/close valve is provided in the gas flow path on one or both of inlet side and outlet side with respect to the evaporator of each refrigeration module.
